(19) United States
(12) Patent Application Publication
(10) Pub. No.: US 2025/0145244 A1
(43) Pub. Date: May 8, 2025

(54) Telescopic Suspension Fork Comprising Two Telescopic Fork Legs

(71) Applicant: KTM AG, Mattighofen (AT)

(72) Inventor: Johannes Wimmer, Kastl (DE)

(21) Appl. No.: 18/934,608

(22) Filed: Nov. 1, 2024

(30) Foreign Application Priority Data
Nov. 3, 2023 (DE) 10 2023 130 444.5

(51) Int. Cl. B62K 25/08; B62J 45/414; B62J 45/423; G01D 5/14

(52) U.S. Cl. CPC B62K 25/08; B62J 45/414; B62J 45/423; G01D 5/145

(57) ABSTRACT

A telescopic suspension fork having two telescopic fork legs, each of which is provided with an outer tube with an axial longitudinal extension and with an inner tube axially displaceable relative thereto in the direction of the axial longitudinal extension, and with an axial longitudinal extension. One telescopic fork leg is a telescopic suspension fork leg with a spring device, and one telescopic fork leg is a telescopic damper fork leg with a damper device and a piston on a piston rod; the telescopic suspension fork has a displacement measuring device configured to detect the distance travelled by the axial displacement of the inner tube relative to the outer tube; the displacement measuring device has a magneto-operational sensor device in an interior space of the piston rod and at least one magnet device at a radial distance from the sensor device.

### CROSS-REFERENCE TO RELATED APPLICATIONS

This application claims priority to German Patent Application No. 10 2023 130 444.5 filed Nov. 3, 2023, the entire contents of which are incorporated herein by reference.

### BACKGROUND OF THE INVENTION

### Field of the Invention

The invention relates to telescopic suspension forks, particularly telescopic suspension forks for mounting on a motorcycle, which may be a road motorcycle or an off-road motorcycle.

### Background Information

It is known to employ sensors in suspension devices to monitor suspension movement so to influence the damping behavior of such the suspension for the purpose of isolating the movement of the vehicle.

European patent document EP 2 036 746 B1 discloses a sensor module including an acceleration sensor for a shock absorber of a passenger car. The sensor module is situated on a recess of a guide bushing for the piston rod, and is located on the outside of the shock absorber. European patent document EP 1 964 696 B1 discloses a shock absorber with a position sensor, in which an evaluation module is likewise arranged on the outer side of the shock absorber, and magnets are disposed on an inner side of the inner tube of the shock absorber along the longitudinal direction of the shock absorber.

Both these arrangements are characterized in that the respective sensor module is arranged on the outside on the outer tube of the respective shock absorber. Such a configuration is disadvantageous if the vehicle is a motorcycle, in particular if it is an off-road motorcycle. Motorcycles are exposed to considerable external influences, such as rain and dirt, and possible damage caused by stones and dust or the like. In a road motorcycle as well, an exposed position of the sensor module on the outer silhouette of the motorcycle is a disadvantage due to the impact from rain and the risk of damage to the sensor module. Furthermore, for both types of motorcycle, there is a risk that the signal quality could be influenced by the transmission of engine vibrations to the externally arranged sensor module.

### SUMMARY OF THE INVENTION

This invention relates to a telescopic suspension fork with two telescopic fork legs. Each fork leg is provided with an outer tube having an axial longitudinal extension and an inner tube that is axially displaceable relative thereto in the direction of the axial longitudinal extension and has an axial longitudinal extension. One telescopic fork leg is a telescopic suspension fork leg provided with a spring device. The other telescopic fork leg is a telescopic damper fork leg with a damper device, and has a piston arranged on a piston rod. The telescopic suspension fork has a displacement measuring device configured to detect the distance travelled by the axial displacement of the inner tube relative to the outer tube. The displacement measuring device has a magneto-operational sensor device in an interior space of the piston rod and at least one magnet device at a radial distance from the sensor device. The invention also includes a motorcycle provided with such a telescopic suspension fork.

The foregoing summary conveys a general understanding of the embodiments of the invention; it is not intended to be limiting.

### BRIEF DESCRIPTION OF THE DRAWINGS

The invention is explained in more detail hereinbelow with reference to the drawing, in which:

FIG. 1 is a longitudinal sectional view of a telescopic suspension fork according to an embodiment of the present invention;

FIG. 2 is a longitudinal sectional view of a telescopic damper fork leg of the telescopic suspension fork according to FIG. 1;

FIG. 3 is a longitudinal sectional view of a telescopic suspension fork leg of the telescopic suspension fork according to FIG. 1;

FIG. 4 is an enlarged view of the section IV taken according to FIG. 2;

FIG. 5 is a longitudinal sectional view of a telescopic suspension fork leg according to a second embodiment;

FIG. 6 is a perspective view of a sensor device according to the present invention;

FIG. 7 is an exploded view of the sensor device seen in FIG. 6; and

FIG. 8 is a side view of a motorcycle equipped with a telescopic suspension fork according to the present invention.

### DISCLOSURE OF THE SPECIFICATION

There is disclosed hereby a telescopic suspension fork having two telescopic fork legs. Each respective fork leg is provided with an outer tube having an axial longitudinal extension and an inner tube that is axially displaceable relative thereto in the direction of the axial longitudinal extension, and has an axial longitudinal extension. A first telescopic fork leg is a telescopic suspension fork leg provided with a spring device. The other telescopic fork leg is a telescopic damper fork leg with a damper device, and has a piston arranged on a piston rod. The telescopic suspension fork has a displacement measuring device configured to detect the distance travelled by the axial displacement of the inner tube relative to the outer tube.

To influence the damping behavior of such a telescopic suspension fork with the aim of isolating the movement of the motorcycle (particularly the fork stem or body of the motorcycle with the telescopic suspension fork) from disruptive excitations, such as uneven road surfaces and the like, knowing the suspension travel and the acceleration of the motorcycle body in the vertical axis direction of the motorcycle as a result of the excitation is important for determining the relative velocity and the vehicle body speed; these values are input parameters used for control according to the principle of the so-called “skyhook controller.” The suspension travel in this case is the distance between two relative positions on the outer tube and on the inner tube as a result of the excitation, i.e., the distance covered by a reference point fixed on the inner tube relative to a reference point fixed on the outer tube as a result of the excitation (caused for example by an uneven road surface). The relative velocity can then be determined by means of a mathematical differentiation of the suspension travel with respect to time. It is, therefore, necessary to determine the suspension travel.

Proceeding from the foregoing, an object underlying the present invention is to provide a telescopic suspension fork comprising two telescopic fork legs, which enables a space-saving arrangement of the sensor device which is protected from damage. The aim is also to provide a motorcycle having such a telescopic suspension fork. To solve this problem, the invention has the features specified herein for the telescopic suspension fork. Advantageous embodiments thereof are described in the further claims.

Here is disclosed herein a telescopic suspension fork featuring two telescopic fork legs, each of which is provided with an outer tube having an axial longitudinal extension and with an inner tube that is axially displaceable relative thereto in the direction of the axial longitudinal extension, and has an axial longitudinal extension. One telescopic fork leg is a telescopic suspension fork leg provided with a spring device, while the other telescopic fork leg is a telescopic damper fork leg provided with a damper device. The latter has a piston arranged on a piston rod, and the telescopic suspension fork has a displacement measuring device configured to detect the distance travelled by the axial displacement of the inner tube relative to outer tube. For sensing motions, the displacement measuring device has a magneto-operational sensor device arranged in an interior space of the piston rod and at least one magnet device at a radial distance from the sensor device.

The telescopic suspension fork according to the invention thus has two telescopic fork legs, each of which has an outer tube and an inner tube, which are displaceable relative to one another and specifically in the axial longitudinal direction. As disclosed, a first telescopic fork leg is a telescopic suspension fork leg and a second telescopic fork leg is a telescopic damper fork leg.

The telescopic suspension fork leg therefore has a main spring supported on a rod, for example, which is supported against a sealing cap, which closes the outer tube at one end region. In this way, the main spring is supported on the sealing cap of the outer tube, and can extend into the end region of the inner tube and be supported there or be supported on a sleeve provided between the end region of the inner tube and the spring. The sleeve can be, for example, a hollow body, which has the advantage that the length of the spring device or main spring decreases, and thus the mass of the main spring decreases.

The telescopic damper fork leg may have a piston or damper piston arranged on a piston rod, through which piston or damper piston damping fluid flows when the inner tube is axially displaced relative to outer tube to perform damping work—and thus to damp the relative movement of the inner tube and in turn to damp the spring movement of the telescopic suspension fork upon external excitation. The telescopic suspension fork leg and the telescopic damper fork leg can be fixed at one end region on a fork bridge of the telescopic suspension fork and at the other end region they can be connected to one another via a floating axle of the front wheel of the motorcycle; the axial displacement of the inner tube of the telescopic damper fork leg thus also leads to an axial displacement of the inner tube of the telescopic suspension fork leg, specifically relative to the respective outer tube of the telescopic damper fork leg and of the telescopic suspension fork leg. Accordingly, the telescopic damper fork leg can provide damping for the telescopic suspension fork as a whole, which only has to have one telescopic damper fork leg for this purpose. The aforementioned axial displacement causes a reference point on the inner tube (for example of the telescopic damper fork leg) to be displaced relative to a reference point on the outer tube of the telescopic damper fork leg during a compression movement or rebound movement of the telescopic suspension fork. This corresponds to the suspension travel of the reference point on the inner tube relative to the reference point on the outer tube, and specifically to excitation caused by the front wheel of the motorcycle driving over uneven ground.

During a compression movement of the telescopic suspension fork, such a suspension travel is detected by the displacement measuring device provided; and during the rebound movement of the telescopic suspension fork as well, the suspension travel of the reference points relative to one another is detected by means of the displacement measuring device according to the invention.

In the case of the telescopic suspension fork according to the invention, the displacement measuring device preferably has a magneto-operational sensor device situated in an interior space of the piston rod, and at least one magnet device radially spaced apart from the sensor device. This configuration, in which the sensor device is arranged in the interior space of the piston rod of the telescopic damper fork leg, leads to the sensor device being protected from dirt, dust, and stones or the like. Protection moreover is provided from interference, for example from engine vibrations induced by a combustion engine, because the piston rod is located in the outer tube of the telescopic damper fork leg (which is filled with damper oil, and both the damper oil and the metal outer tube act as a shield against the engine vibrations).

Although it is stated above that the sensor device is arranged in an interior space of the hollow piston rod of the telescopic damper fork leg, it is also may be provided that the sensor device is arranged in a hollow push rod of the telescopic suspension fork leg, on which the main spring of the telescopic suspension fork leg may be supported. The magnet device can then be arranged on a support or receptacle on which the spring device is supported. In this embodiment, the magnet device can also be at a radial distance from the sensor device or also radially surround the latter. The invention therefore provides both mounting options for the magneto-operational sensor device. It is provided that the displacement measuring device has at least one magnet device at a radial distance from the sensor device.

When the magnet device is arranged at a radial distance from the sensor device, the sensor device advantageously can detect a three-dimensional magnetic field of the magnet device in order to determine the suspension travel. The arrangement of the magnet device at a radial distance from the sensor device means that the radial distance between the sensor device and the magnet device remains constant during an axial movement of the magnet device relative to the sensor device, because the sensor device is advantageously arranged in the center of rotation of the piston rod. Therefore, the rotational position of the magnet device relative to sensor device, which is set when the telescopic fork leg having the magnet device and the sensor device is assembled, plays no role in the subsequent functioning of the suspension travel detection. This facilitates assembly and reduces assembly errors.

The magnet device can be a disc-shaped magnet or, for example, a cylindrical magnet. The radial distance between the magnet and the sensor device means that the radial distance remains the same during the relative movement of the inner tube relative to the outer tube; therefore the magnetic field detected by the sensor device is only dependent on the relative movement of the inner tube with respect to outer tube in the axial longitudinal direction of the inner tube.

It is possible according to one embodiment of the invention that the magnet device is a ring magnet which radially surrounds the sensor device. Such a ring magnet generates a three-dimensional magnetic field, which is detected by the magneto-operational sensor device and is evaluated to determine the suspension travel. According to the invention, an evaluation device formed integrally with the magneto-operational sensor device can be used to determine the suspension travel. Alternatively, it can also be determined, for example, by a control device on the motorcycle, e.g., a device which determines the suspension travel and simultaneously provides control signals provided to control an electromagnetic coil with which a control valve or control valves on the damping piston of the telescopic damper fork leg are controlled. This is to influence the opening characteristic of the control valve, i.e., which gap area of the control valve is released for the passage of damping fluid or over which period of time the gap area is released—thereby allowing the damping work of the telescopic damper fork leg be adapted to the respective requirements. This control device may be a device arranged in the engine control unit of the motorcycle or else, for example, a separate chassis control unit or a chassis controller.

The magneto-operational sensor device is able to detect the three-dimensional magnetic field of the magnet device. The magnet device (for example the aforementioned ring magnet, or the cylindrical magnet or a disc-shaped magnet) has a three-dimensional magnetic field emanating from it, which has a predetermined spread or extension in the three spatial directions around the magnet. The cylindrical magnet has a central axis extending along the cylinder vertical axis, which is oriented at an angle, example at a right angle, to the central axis of the piston rod. The cylindrical magnet can therefore be arranged on a cap device or a cap or a sealing cap, which closes an upper end region of the inner tube of the telescopic fork leg (specifically for example in a recess of an outer circumferential region of the cap device); the recess has an inner circumferential lateral surface which receives the outer circumferential lateral surface of the cylindrical magnet. Depending on the suspension travel provided by the telescopic suspension fork, which can be up to 350 millimeters for an off-road motorcycle, the invention provides that the sensor device has multiple sensor elements along the length of the sensor device.

This configuration leads to the magnet device being guided past multiple sensor elements during the compression movement when a motorcycle rides over uneven ground, which leads to a compression movement of the telescopic suspension fork of, for example, 175 millimeters. Each sensor element has a predetermined detection range, which corresponds to a suspension travel of approximately 35 millimeters. Accordingly, for a possible suspension travel of about 350 millimetres, multiple (for example up to ten) sensor elements are provided on the sensor device along the length thereof; in such an exemplary embodiment, each sensor element has a detection range of approximately 35 millimeters suspension travel in the axial longitudinal direction of the telescopic fork leg. The number of sensor elements can therefore be adapted to the desired detection range or desired suspension travel of the motorcycle equipped with the presently disclosed system.

Because the magnet device is radially spaced apart from the sensor device (or radially surrounds the latter), such as in the example of a magnet device designed as a ring magnet, the radial distance between the magnet device and the sensor elements is constant and the effective magnetic field is dependent only on the displacement of the magnet device in the axial longitudinal direction of the sensor elements. The distance between the magnet device and the sensor element (or multiple sensor elements), and the field strength of the magnet device, result in a useful measurement range in the axial longitudinal direction. The desired overall detection range of the sensor device can be set by an arrangement of multiple sensor elements along the axial longitudinal direction of the sensor device, for example corresponding to the above-mentioned possible suspension travel of the telescopic suspension fork according to the invention.

Because the magnet device is arranged at a radial distance from the sensor device, the detection of the magnetic field by the sensor device (the sensor element or the sensor elements), is independent of the rotation angle or the rotation angle position of the magnet device around the sensor device. Any change in the rotational position of the magnet device relative to the sensor device does not therefore lead to a change in the magnetic field detected by the sensor device.

The sensor element or the sensor elements can be a Hall sensor or Hall sensors, which are configured for the three-dimensional detection of a magnetic field.

One aspect of the invention is that the inner tube of the telescopic damper fork leg has an end region arranged in the outer tube, and the end region has a cap device through which the piston rod passes; the magnet device is arranged on an outer circumferential region of the cap device in a rotationally fixed manner. An axial relative movement of the inner tube relative to the outer tube results in a displacement of the cap device with the magnet device relative to the piston rod, and therefore also relative to the sensor device with the sensor element(s), which is located in the piston rod. This changes the magnetic field detected by the sensor element(s) along the axial longitudinal direction of the piston rod. The position of the magnet device therefore represents a reference point for the sensor device, the axial positional change of which is detected by the sensor device by means of the sensor element(s). From this the distance covered during the current axial displacement of the inner tube relative to outer tube between the reference point in its starting position and the reference point in its end position (i.e., the end of the distance travelled by the reference point during the compression movement), is determined. This results in the suspension travel sᵣₑₗ covered, and the relative velocity vᵣₑₗ of the compression movement can then be determined therefrom via the mathematical differentiation of the suspension travel with respect to time. The body velocity v_{body} of the motorcycle body can be determined by additionally detecting the value of the body acceleration a_{body} of the motorcycle body by means of an acceleration sensor and numerical integration over time.

The values determined thereby are then used to determine the minimum damping cₘᵢₙ and the maximum damping cₘₐₓ, from which the desired degree of damping c for damping the compression movement can be determined according to the following relationship of a Skyhook controller:

cₘᵢₙ if v_{body} · vᵣₑₗ ≤ 0
cₘₐₓ if v_{body} · vᵣₑₗ > 0

One aspect of the invention is that the sensor device has an elongate housing with an interior recess in which an elongate circuit board having Hall sensors arranged at a distance from each other along the longitudinal direction of the circuit board is arranged; the circuit board together with the Hall sensors in the interior recess are encapsulated with a potting compound.

The circuit board can be a printed circuit board, which has conductor tracks for supplying with electric poser the Hall sensors arranged thereon (at a distance from each other). The circuit board can, moreover, have connection elements for connecting connection cables to supply the electrical power. The circuit board can be arranged together with the Hall sensors in the elongate housing (and specifically in the interior recess of the housing), wherein the interior recess is encapsulated with a potting compound (after the arrangement of the circuit board with the Hall sensors). The potting compound ensures that the circuit board with the Hall sensors is securely held in the housing, and protects against shocks or shaking or vibrations coming from a combustion engine of the motorcycle. This further improves the quality of the signals output by the Hall sensors via conductor tracks on the circuit board, which signals result from the detection of the above-mentioned magnetic field. Also arranged on the above-mentioned printed circuit board may be the acceleration sensor, with which the acceleration of the body of the motorcycle can be detected, which is used in the above-mentioned Skyhook controller to determine the desired damping.

The travel signals and the acceleration signal are routed, for example as a pulse-wave modulated signal, to an evaluation device. The evaluation device may be the above-mentioned chassis controller for example. The routing is via cables arranged on the printed circuit board and the previously-mentioned connection cables which lead into the interior recess of the piston rod on the circuit board side.

Another aspect of the invention is that the housing preferably is formed from a plastic material and has a circular end face on both opposite end regions; one end face is provided with a passage configured to receive electrical connection means. This creates a housing which complements the interior space of the piston rod in terms of shape and surface area. Owing to this configuration, the housing with the sensor device can be arranged in the piston rod with a positive fit and be fixed there, so to prevent the housing from moving in the interior recess (which could lead to the sensor device arranged in the housing becoming damaged). An end face of the housing is provided with a passage, which is provided by electrical connection means for the sensor device, i.e. for the above-mentioned 3D Hall sensors. In addition, these connection means, e.g., electrical connection cables, may also comprise a cable for energizing an electromagnetically actuated solenoid, which is provided to control valve shims for controlling the flow of damping oil through the damper piston.

An aspect of the invention is that the sensor device is arranged in the rotational axis of the piston rod, and is designed to detect the three-dimensional magnetic field of the magnet device moving relative to the sensor device. The sensor device can thus detect the magnetic field generated by the magnet device in all three spatial directions, and generate signals therefrom. The signals are forwarded to an evaluation unit which may be the above-mentioned chassis controller, for example. The chassis controller evaluates these signals which, because of the feature that the sensor device is located in the rotational axis of the piston rod, is independent of the rotational position of the piston rod relative to the ring magnet.

The longitudinal axis of the sensor device can be defined as the X axis, and also corresponds to the longitudinal axis of the telescopic fork leg provided with the sensor device. This longitudinal axis is located in the center of rotation of the aforementioned telescopic fork leg, for example of the telescopic damper fork leg.

In a cartesian coordinate system, the Z-Y plane is perpendicular to the X axis and the sensor device can detect the effective magnetic field B_{eff} in the Z-Y plane, and specifically according to the formula:

$${B}_{e f f} = \sqrt{{B}_{Z}^{2} + {B}_{y}^{2}}$$

Because the radial distance between the magnet and the respective sensor element of the sensor device (for example the aforementioned Hall sensor or the aforementioned Hall sensors) always remains the same—since the sensor element or the sensor elements is located in the center of rotation of the fork tube having the piston rod—the value of the effective magnetic field B_{eff} is only dependent on the shifting or axial displacement of the magnet device along the X axis and independent of the rotation angle of the magnet device; for example of the magnet or ring magnet around the sensor element or around the sensor elements. The distance between the magnet and the sensor element or the sensor elements and the field strength of the magnet results in a useful measurement range along the X axis, which can be approximately 35 millimeters, for example.

For larger measurement ranges, as is already mentioned above, multiple sensor elements are arranged along the circuit board or conductor plate. Owing to the detection of the magnetic field in the X direction, i.e. Bₓ, and the detection of the effective magnetic field B_{eff}, the reference point can be unambiguously determined along the X axis within the measurement range. This makes it possible to determine the displacement of the reference point along the X axis during a compression movement or a rebound movement of the telescopic suspension fork and thus the magnitude of the compression movement or rebound movement.

Another aspect of the invention is that the sensor device has an acceleration sensor configured to detect the acceleration of the vehicle body of a vehicle, in particular a motorcycle, provided with the telescopic suspension fork. The acceleration sensor in this embodiment advantageously may be arranged on the aforementioned circuit board, and is also supplied with electric power via the same. The acceleration signals determined by the acceleration sensor are forwarded via the circuit board and the aforementioned connection cables or connection means to an evaluation device, which may be the aforementioned chassis controller.

Another aspect of the invention is that the telescopic suspension fork leg has a fist clamp for a front wheel axle of a motorcycle at one end region. It also has, at the end region lying opposite in the longitudinal direction of the telescopic suspension fork leg, a cap which seals the outer tube and which is provided with an O-ring on a surface lying opposite the end region of the inner tube. This produces a configuration of the telescopic suspension fork leg in which an end stop for the inner tube is provided by the O-ring which is arranged on the cap sealing the outer tube. The inner tube slides relative to the inner circumferential surface of the outer tube during an axial movement of the inner tube relative to outer tube, so that no sliding surface is needed on the spring rod, which is provided to support the main spring or compression spring and is supported on the cap of the outer tube, thereby creating a cost-effective configuration of the telescopic suspension fork leg.

Still another aspect of the invention is that the telescopic suspension fork leg has, at an end region of the inner tube, a cap provided with a passage to receive a push rod, and the spring device is supported at one end region on the push rod and is supported at the opposite end region on a sleeve-shaped body arranged in the inner tube. The push rod can be the above-mentioned spring rod and together with the sleeve-shaped body, on which the main spring can be supported, it is possible to use a main spring with a shorter axial length than would be the case if the main spring were to extend into the region of a fist clamp for the front axle. This configuration thus means that the mass of the telescopic suspension fork leg can be reduced.

An aspect of the invention is that the telescopic damper fork leg is designed as a twin rod damper, and has a second rod arranged in a damper tube, which second rod is supported on the damper piston and the outer diameter of which is smaller than the outer diameter of the piston rod. The rod diameter of the second rod ensures that less damping fluid, i.e. damping oil, has to flow through the valve when the spring moves and thus in the case of telescopic suspension forks with a long suspension travel, which are used primarily off-road, i.e. for example in motocross motorcycles, a weight reduction of the overall mass of the telescopic suspension fork can also be realised thereby.

A further refinement of the invention is that the telescopic damper fork leg has an electrically actuatable coil or solenoid. This coil or solenoid may be supplied with electrical power by means of the above-mentioned connection cables so to actuate an actuator, which in turn actuates valve discs or valve shims, by means of the actuation of which the flow cross-section through the valve body can be influenced, so as to be able to control the damping work performed by the damper device.

Another refinement of the invention is that the telescopic suspension fork has at least one fork bridge configured to receive the telescopic fork legs. The fork bridge may have two receiving openings for this purpose, into which the telescopic fork legs can be inserted and are enclosed by the receiving openings and are releasably fixed therein. In one embodiment of the telescopic suspension fork according to the invention, the telescopic fork legs have an upper fork bridge and, arranged at a distance from the latter, a lower fork bridge.

Lastly, according to the invention, a motorcycle with a front wheel and a rear wheel as well as a rider's saddle and a drive unit is also provided. The drive unit can be a combustion engine or an electric drive unit, wherein the motorcycle has a telescopic suspension fork that supports the front wheel of the motorcycle.

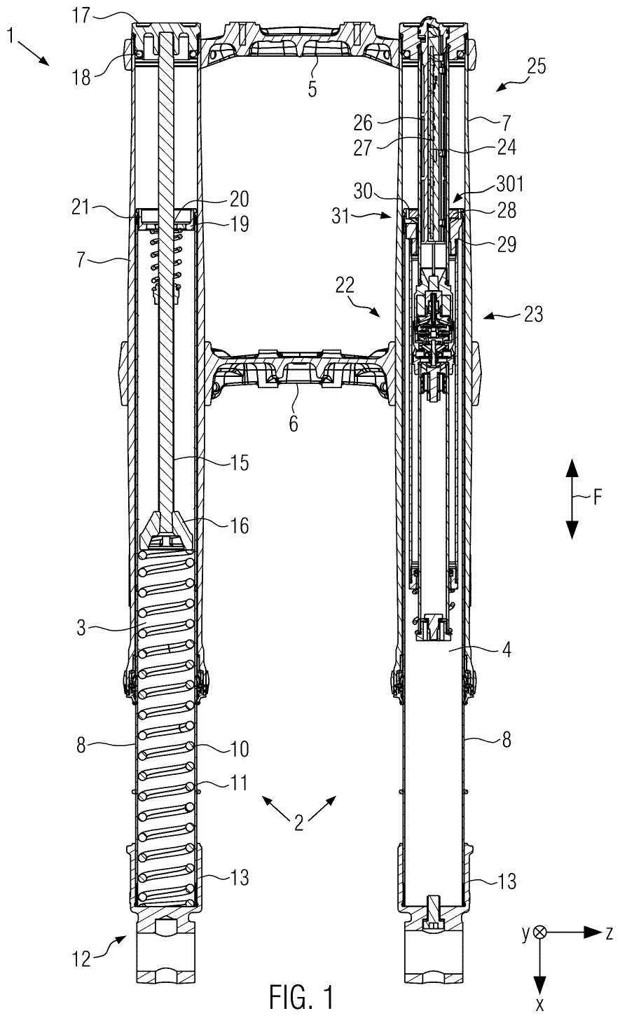

Attention now is directed to FIG. 1, showing a longitudinal sectional view of a telescopic suspension fork 1 with two telescopic fork legs 2 according to an embodiment of the present invention. The telescopic fork leg 2 shown on the left in the figure is a telescopic suspension fork leg 3 and the telescopic fork leg 2 shown on the right in the drawing is a telescopic damper fork leg 4. Additionally, the telescopic suspension fork 1 has an upper fork bridge 5 and a lower fork bridge 6, by means of which the two telescopic fork legs 2 are releasably connected to one another.

The telescopic suspension fork leg 3 has an outer tube 7 and an inner tube 8. The inner tube 8 can be axially displaced relative to outer tube 7 in direction of its axial longitudinal extension along the arrow F according to FIG. 1; the displacement may be, for example, the result of the motorcycle 9 equipped with the telescopic suspension fork 1 according to the invention being ridden. Similarly, the telescopic damper fork leg 4 also has an outer tube 7 and an inner tube 8, which can also be axially displaced relative to outer tube 7 in the direction of the axial longitudinal extension along the arrow F when the motorcycle 9 is being ridden. Both inner tubes 8 can therefore perform a compression movement and a rebound movement relative to respective outer tube 7.

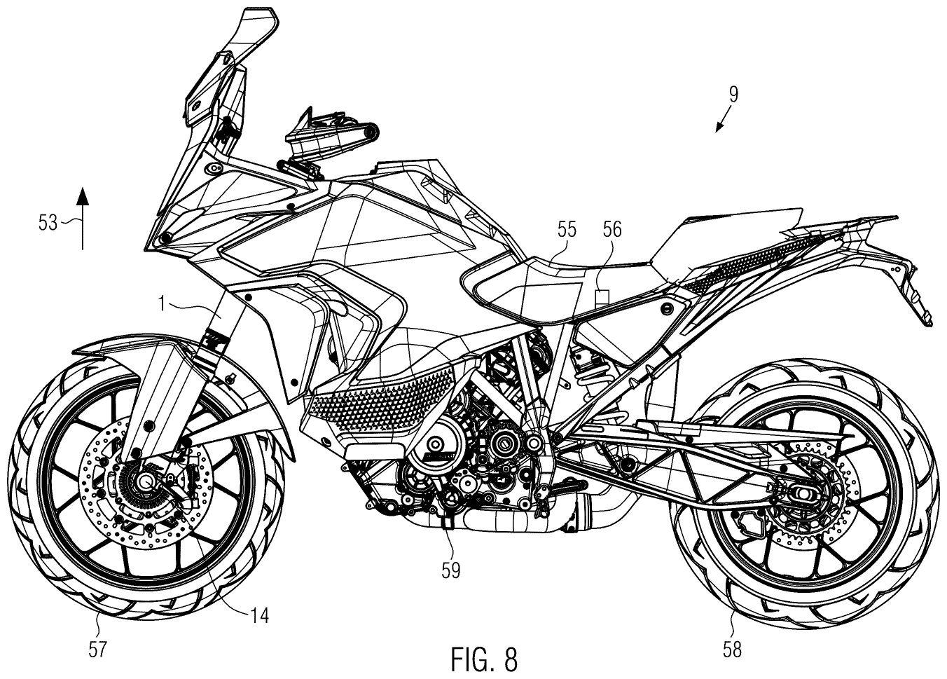

The telescopic suspension fork leg 3 has a spring device 10 in the form of a main spring 11 which is supported on the inner tube 8 at the lower end region 12 in the plane of the drawing, with the inner tube 8 being supported on a fist clamp 13 which is designed to receive and releasably fix a front wheel axle 14 (which can be seen in FIG. 8). The main spring 11 is supported at the end region, which is opposite the fist clamp 13, on a receptacle 16, which in turn is supported on a push rod 15. The push rod 15 is supported on a cap 17 which closes the outer tube 7, as can be seen in FIG. 1.

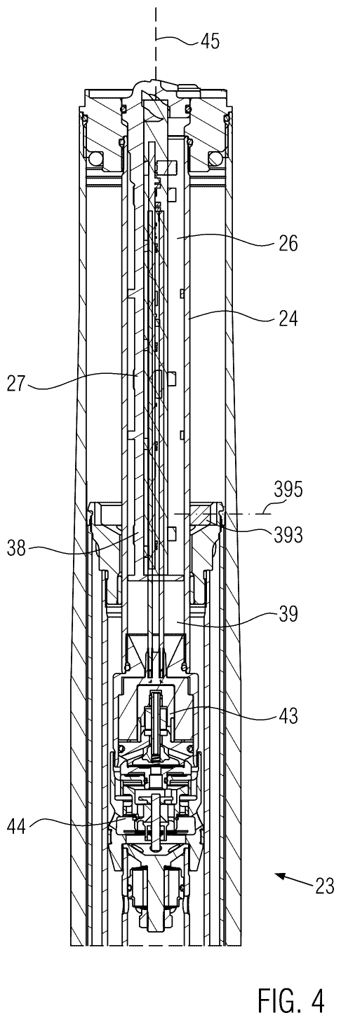

An O-ring 18 is on the underside of the cap 17. The O-ring serves as end stop for the inner tube 8 during a compression movement of the inner tube 8 up to the region of the cap 17. The inner tube 8 of the telescopic suspension fork leg 3 is sealed at the end region opposite the fist clamp 13 via a cap 19; the cap has a passage 20 for receiving the push rod or spring rod 15. The cap 19 can come to rest with its outer circumferential edge 21 on the O-ring 18, so that the above-mentioned end stop is enabled for the compression movement of the inner tube 8 relative to the outer tube 7 of the telescopic suspension fork leg 3. Because the two telescopic fork legs 2 move together during a compression movement, the end stop realized in this way also simultaneously serves as a limit for the compression movement of the telescopic damper fork leg 4. The telescopic damper fork leg 4 has a damper device 22 configured as a twin rod damper 34. This has a piston 23 which is on a piston rod 24, as can be seen in FIGS. 1 and 4.

The inner tube 8 of the telescopic damper fork leg 4 is arranged on the underside, in the plane of the drawing, again on a fist clamp 13—as has already been explained above for the telescopic suspension fork leg; the two fist clamps 13 therefore serve for the arrangement of the front wheel axle 14 of the motorcycle 9, shown in FIG. 8.

The telescopic suspension fork 1 has a displacement measuring device 25 configured to detect the distance travelled by the axial displacement of the inner tube 8 relative to the outer tube 7. The displacement measuring device 25 can therefore be used to determine the distance travelled by a reference point lying on the inner tube 8 relative to a reference point lying on the outer tube 7 during a compression movement and also a rebound movement of the telescopic suspension fork 1 according to the invention. Broadly speaking, the suspension travel experienced by the telescopic suspension fork 1 during a compression movement or a rebound movement can thus be determined.

Knowing the suspension travel is important, for example, for influencing the damping characteristics of the damper device 22. The damper device 22 can be used to meet the needs of the motorcycle 9 (or the wishes of a rider of the motorcycle 9) regarding the damping of the chassis of the motorcycle 9. As a result, riding programs are possible which require different damping behavior of the telescopic suspension fork 1. In this way, the suspension and damping behavior of the chassis of the motorcycle 9 can be influenced.

The displacement measuring device 25 has a magneto-operational sensor device 27 arranged in an interior space 26 of the piston rod 24 and, interacting therewith, a magnet device 28 arranged at a radial distance from the sensor device 27. The sensor device 27 is shown in FIG. 1 arranged in the interior space 26 of the piston rod 24; the magnet device 28, as a ring magnet 29, radially surrounds the sensor device 27 and is arranged at a radial distance from the sensor device 27. In the embodiment shown, the magnet device 28, 29 is arranged in a receptacle 30 of a cap device 301 on the upper end region 31 of the inner tube 8 of the telescopic damper fork leg 4. The receptacle 31 can be a circular groove, for example, which is open at the top so that the ring magnet 29 can easily be inserted into the circular groove and can be fixed there, for example by means of a force fit.

If, during a compression movement or rebound movement, the inner tube 8 of the telescopic damper fork leg 4 performs a displacement movement of the ring magnet 29 relative to the sensor device 27, this leads to a change in the magnetic field measured at the respective place in the axial longitudinal direction of the sensor device 27—i.e., the field strength of the magnetic fields changes, from which the effective magnetic field B_{eff} can be determined according to the above-explained relationship; such can be evaluated to determine the displacement movement of the ring magnet 29 reference point relative to the sensor element reference point(s) of the sensor device 27, measured in the X direction according to FIG. 1. The sensor device 27 therefore has a reference point or reference points in the form of a sensor element 32, or sensor elements arranged at a distance from each other along the longitudinal direction of the sensor device 27, as seen in FIG. 7.

If, during a compression movement or a rebound movement, the ring magnet 29 therefore performs an axial displacement relative to the sensor element(s) 32 of the sensor device 26, the magnetic field measured by each sensor element 32 changes. From this change the respective magnitude of the displacement movement of the ring magnet within the respective measuring range of the respective sensor element 32 can be determined, and the displacement travel and thus the suspension travel can be determined therefrom.

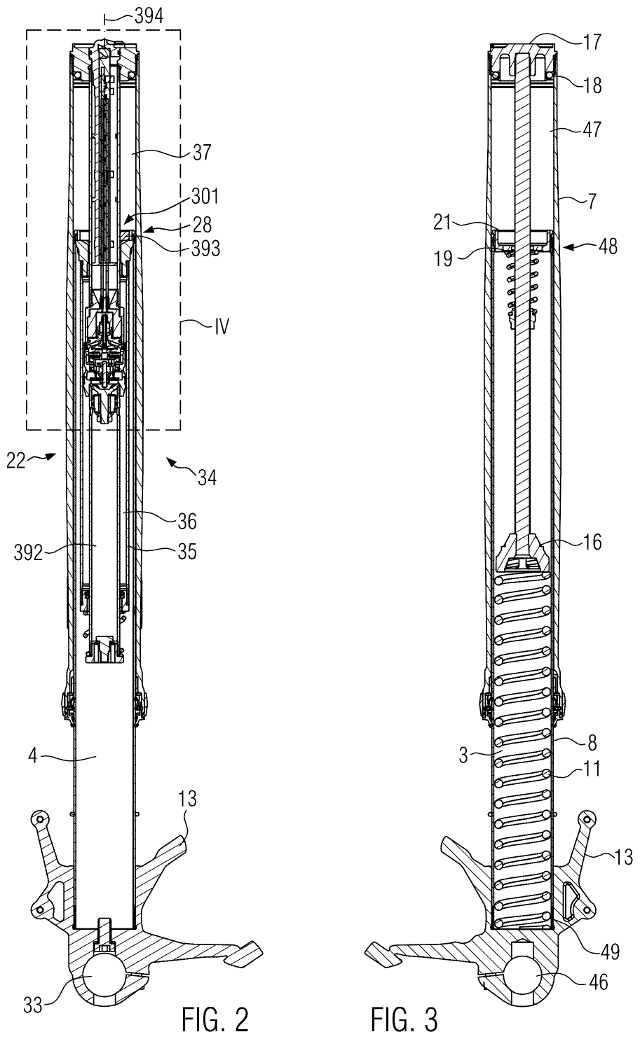

FIG. 2 of the drawing shows a longitudinal sectional view of the telescopic damper fork leg 4 according to FIG. 1, with the fist clamp 13 and the receptacle 33 of same for the front axle 14 of the motorcycle 9. In the embodiment of FIG. 2, the magnet device 28 is a cylindrical magnet 393 arranged in a receptacle of the cap device 301, and specifically such that the cylinder longitudinal axis or cylinder vertical axis 395 of the magnet 393 is oriented at a right angle to the central axis 394 of the piston rod 24. This means that, during an axial spring movement of the telescopic suspension fork 1 in the direction of the arrow F according to FIG. 1, the magnet 393 performs a relative movement in the direction of the arrow F relative to piston rod 24, but the radial distance between the sensor device 27 and the magnet 393 stays the same in process. In addition, FIG. 2 shows that the damper device 22 is configured as a twin rod damper 34 with a damper tube 35, a first pressure chamber 36, and a second pressure chamber 37.

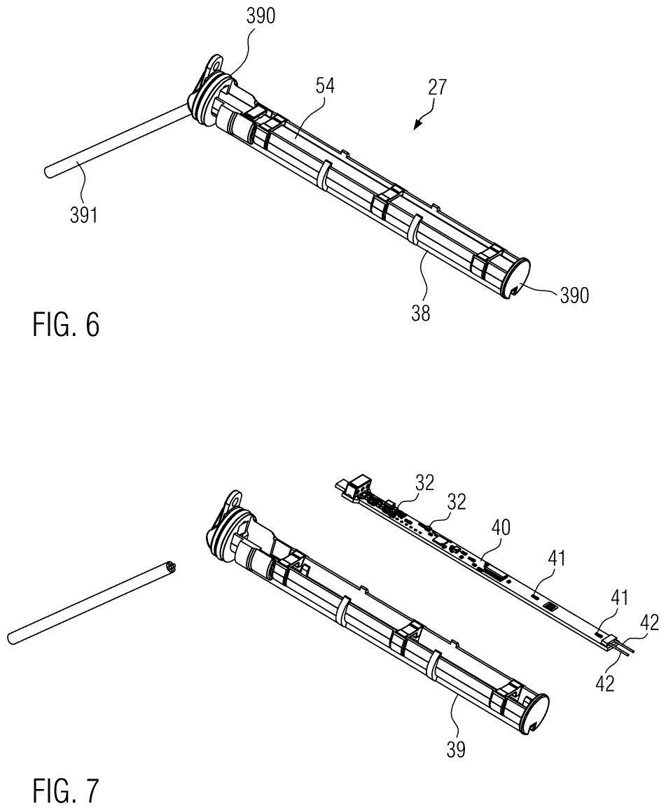

FIG. 4 is an enlarged illustration of the section IV according to FIG. 2. The piston rod 24 receives the sensor device 27 in the interior space 26 of the piston rod, and specifically such that the sensor device (which can be seen in more detail in FIG. 6) with the housing 38 is in the interior space 26. The housing 38 has an elongate configuration, as seen FIG. 6, and has a respective end face 390 on both opposite end regions, which is circular and complementary to the configuration of the interior spaces 26 of the piston rod 24 in terms of shape and surface area. The outer diameter of the end face 390 largely corresponds to the inner diameter of the interior space 26 of the annular piston rod 24, so that the sensor device 27 (with the housing 38) can be inserted into the interior space 26 of the piston rod 24 and is radially fixed there. The end face 390 which can be seen in the drawing plane of FIG. 6 has a passage to receive the connection means 391 that are there seen.

The housing 38 of the sensor device 27, which can be seen in more detail in FIG. 6, has an interior space or an interior recess 39 (visible in FIG. 7), in which the elongated circuit board 40 of the sensor device 27 can be introduced. The circuit board 40 has sensor elements in the form of 3D Hall sensors 41 located at a distance from each other, configured to detect the magnetic field induced by the ring magnet 29. In addition, the circuit board 40 also has two connection cables 42, for supplying with electric power the solenoid 43 (FIG. 4). The power supply of the solenoid 43 is therefore looped through the circuit board 40; with the solenoid 43, the spring washers or valve shims 44 (FIG. 4) can be actuated so that the opening cross-section of the passage of the damper piston 23, able to be released in an open-loop or closed-loop manner by the spring washers 44, can be changed to alter the damping behavior of the damper device 22; thereby the damping behavior of the telescopic damper fork leg 4 can be changed, and thus so can the overall damping behavior of the telescopic suspension fork 1.

Because the sensor device 27 is arranged along the rotational axis 45 of the piston rod 24 seen in FIG. 4, the rotational angle position of the ring magnet 29 relative to the piston rod 24 plays no role, and the effective magnetic field can be unambiguously determined, as has already been explained above (per the given formula).

FIG. 3 offers a further view of the telescopic suspension fork leg 3 illustrated in FIG. 1. As can readily be seen, the fist clamp 13 has a receptacle 46 for the front axle 14 of the motorcycle 9. The cap 17 seals the outer tube 7 and the above-mentioned O-ring 18 is arranged at the end region associated with an interior recess 47 of the outer tube 7; the O-ring serves as an end stop for the end region 48 of the inner tube 8 sealed with the cap 19. The outer circumferential edge 21 of the cap 19 can come to rest on the O-ring 18 when the telescopic suspension fork leg 3 has covered the maximum possible suspension travel. As can be seen from FIG. 3, the main spring 11 has an axial longitudinal extension which extends from the receptacle 16 to the end region 49, which is associated with the fist clamp 13.

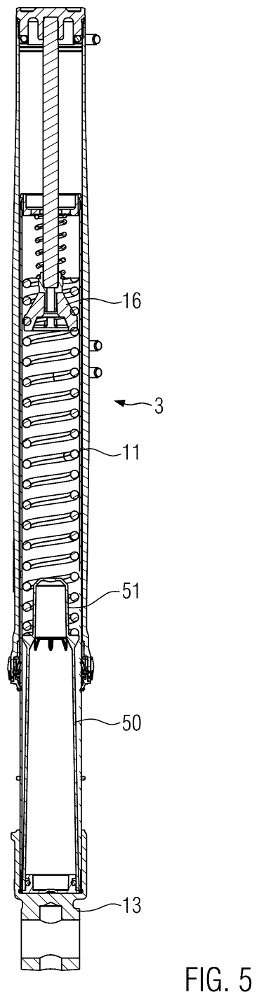

The modified embodiment of the telescopic suspension fork leg 3 shown in FIG. 5 has a shorter main spring 11, which extends from the receptacle 16 up to a sleeve-shaped body 50, on the front end region 51 of which the main spring 11 is arranged in a guided manner. The sleeve-shaped body 50 serves as spacer sleeve and abutment for the main spring 11. Because the main spring 11 in the embodiment according to FIG. 5 has a shorter axial longitudinal extension, it also has a smaller intrinsic mass, and the intrinsic mass of the telescopic suspension fork leg 3 as a whole is reduced as a result.

Arranged on the circuit board 40, as seen in FIG. 7, is an acceleration sensor 52 with which the acceleration of the vehicle body of the motorcycle 9 can be established in the vertical axis direction 53. The values determined by the acceleration sensor 52 can be supplied, together with the values of the magnetic field strength determined by the Hall sensors 41, to a control device in the form, e.g, of a chassis controller 56 provided on the motorcycle 9 under the bench seat 55 (FIG. 8). The control device 56 controls the damping characteristics of the telescopic suspension fork 1 by energizing the solenoid 43 in accordance with the selected driving program. The circuit board 40 with the sensors 41, 52 can be encapsulated with a potting compound 54, meaning that all the electronic components on the circuit board 40 are encapsulated by the potting compound 54 and are thus protected.

FIG. 8 shows a motorcycle 9 with a front wheel 57, a rear wheel 58, the abovementioned bench seat 55 (which serves as a rider's saddle), and a drive unit 59 in the form of a combustion engine. The motorcycle 9 has the telescopic suspension fork 1 that has been explained above in detail and, in the embodiment shown of the motorcycle, is designed as a road motorcycle. The telescopic suspension fork 1 according to the invention is characterized by, inter alia, a low intrinsic mass, since, for example, only a main spring 11 is provided; and by designing the telescopic damper fork leg 4 as a twin rod damper, only a small amount of damping fluid is displaced to damp the spring movement, and therefore the volume of damping fluid can also be reduced—whereby the intrinsic mass of the telescopic suspension fork 1 according to the invention in turn can be reduced.

The telescopic suspension fork 1 according to the invention is therefore also provided for arrangement on an off-road motorcycle, for the use of which on unsurfaced terrain the telescopic suspension fork 1 according to the invention is advantageous because of its low intrinsic mass. This also applies to the use of the telescopic suspension fork 1 according to the invention on a road motorcycle.

The telescopic suspension fork according to the invention is also characterized in that the supply line needed for supplying the solenoid with electric power and the connection cables for the sensor device can be combined to form a single plug-in device, and thus only one plug-in device is needed on the telescopic damper fork leg. The sensor device is integrated in the hollow piston rod, whereby the otherwise unused interior space of the piston rod is used. In addition, the sensor device is accommodated in the piston rod protected from dirt and vibrations and shocks.

The telescopic suspension fork according to the invention has a very good off-road capability, as only a single plug-in device is needed, as has already been explained above, and can in addition also be equipped with an additional pneumatic spring which can be integrated in the telescopic suspension fork leg as a pneumatic spring unit. The O-ring on the upper sealing cap of the telescopic suspension fork leg serves as an end stop and the cap in the inner tube can serve as a cable stop. The push rod or spring rod, which supports the main spring of the telescopic suspension fork leg, does not require a sliding surface and therefore ensures that the telescopic suspension fork leg has a cost-effective design.

The configuration of the telescopic damper fork leg as a twin rod damper ensures that no additional gas pressure is needed, and damping forces can be provided in the tensile direction and the compression direction in accordance with the intended use of the innovatively equipped motorcycle. The large rod diameters of the telescopic damper fork leg ensure that the flow of pressure fluid through the valve assembly can be reduced, which is especially advantageous for off-road use. The displacement measuring device can be integrated protected in the hollow piston rod and because only one plug connection is needed, additionally the susceptibility of this connection to disruptive external influences is also reduced.

During the compression movement, both pressure chambers of the twin rod damper are placed under pressure, and therefore an additional gas pressure device is not needed. By integrating the sensor device in the hollow piston rod, the sensor device is well protected from environmental influences. Further, the integration of the ring magnet in the cap of the inner tube, which may be a screw-on cover, ensures that the relative rotational angle position of the ring magnet relative to the sensor device exerts no influence on the travel detection by the 3D Hall sensors.

With regard to features of the invention not explained further in detail above, express reference is otherwise made to the claims and the drawing.

### LIST OF REFERENCES

1. telescopic suspension fork
2. telescopic fork leg
3. telescopic suspension fork leg
4. telescopic damper fork leg
5. upper fork bridge
6. lower fork bridge
7. outer tube
8. inner tube
9. motorcycle
10. spring device
11. main spring
12. lower end region
13. fist clamp
14. front wheel axle
15. push rod
16. receptacle
17. cap
18. O-ring
19. cap
20. passage
21. outer circumferential edge
22. damper device
23. piston
24. piston rod
25. displacement measuring device
26. interior space
27. sensor device
28. magnet device
29. ring magnet
30. receptacle
31. end region
32. sensor element
33. receptacle
34. twin rod damper
35. damper tube
36. pressure chamber
37. pressure chamber
38. housing
39. interior space, interior recess
40. circuit board
41. Hall sensor
42. connection cables
43. solenoid
44. spring washers
45. rotational axis
46. recess
47. interior recess
48. end region
149. end region
50. sleeve-shaped body
51. end region
52. acceleration sensor
53. vertical axis direction
54. potting compound
55. bench seat, rider's saddle
56. chassis controller
57. front wheel
58. rear wheel
59. drive unit
301. cap device
390. end face
391. connection means
392. second rod
393. cylindrical magnet
394. central axis
395. cylinder vertical axis

What is claimed is:

1. A telescopic suspension fork comprising two telescopic fork legs, each with an outer tube having an axial longitudinal extension and an inner tube axially displaceable relative thereto in the direction of the axial longitudinal extension and has an axial longitudinal extension, wherein one of the telescopic fork legs is a telescopic suspension fork leg with a spring device, and the other telescopic fork leg is a telescopic damper fork leg having:
a damper device; and
a piston arranged on a piston rod;
wherein the telescopic suspension fork has a displacement measuring device for detecting a distance travelled by the axial displacement of the inner tube of the telescopic damper fork leg relative to the outer tube, wherein the displacement measuring device has a magneto-operational sensor device in an interior space of the piston rod and at least one magnet device at a radial distance from the sensor device.

2. The telescopic suspension fork according to claim 1, wherein:
the inner tube of the telescopic damper fork leg has an end region arranged in the outer tube, and the end region has a cap device through which the piston rod passes; and
the magnet device is rotationally fixed on an outer circumferential region of the cap device.

3. The telescopic suspension fork according to claim 1, wherein:
the sensor device has an elongate housing with an interior recess containing an elongate circuit board mounting Hall sensors arranged at a distance from each other along the longitudinal direction of the circuit board; and
the circuit board, together with the Hall sensors in the interior recess, are encapsulated with a potting compound.

4. The telescopic suspension fork according to claim 3, wherein the housing comprises a plastic material and has a circular end face on both opposite end regions, and one of the end faces has a passage configured to receive electrical connection means.

5. The telescopic suspension fork according to claim 1, wherein the sensor device is on the rotational axis of the piston rod and detects the three-dimensional magnetic field of the magnet device moving relative to sensor device.

6. The telescopic suspension fork according claim 1, wherein the sensor device has an acceleration sensor for detecting the acceleration of the body of a motorcycle.

7. The telescopic suspension fork according to claim 6, wherein the telescopic suspension fork leg has:
a fist clamp, for a front wheel axle of the motorcycle, at one end region; and
a cap at a second end region lying opposite in the longitudinal direction of the telescopic suspension fork leg for sealing the outer tube, provided with an O-ring on a surface lying opposite the end region of the inner tube.

8. The telescopic suspension fork according to claim 6, wherein:
the telescopic suspension fork leg has, at an end region of the inner tube, a cap with a passage for receiving a push rod; and
the spring device is supported at one end region on the push rod and is supported at an opposite other end region on a sleeve-shaped body in the inner tube.

9. The telescopic suspension fork according to claim 6, wherein:
the telescopic damper fork leg is a twin rod damper with a second rod in a damper tube; and
the second rod, supported on the damper piston, has an outer diameter smaller than the outer diameter of the piston rod.

10. The telescopic suspension fork according to claim 1, wherein the telescopic damper fork leg has an electrically actuatable solenoid.

11. The telescopic suspension fork according to claim 10, wherein the connection means comprise an electrical connection cable for energizing the electrically actuatable solenoid.

12. The telescopic suspension fork according to claim 6 further comprising at least one fork bridge configured to receive the telescopic fork legs.

13. The telescopic suspension fork according to claim 1 on a motorcycle comprising a front wheel, a rear wheel, a rider's saddle, and a drive unit.
